(19) United States
(12) Patent Application Publication
(10) Pub. No.: US 2025/0121311 A1
(43) Pub. Date: Apr. 17, 2025

(54) Fresh Air Filter

(71) Applicant: William Roach, Plymouth, MN (US)

(72) Inventor: William Roach, Plymouth, MN (US)

(21) Appl. No.: 18/913,555

(22) Filed: Oct. 11, 2024

Related U.S. Application Data
(60) Provisional application No. 63/589,560, filed on Oct. 11, 2023.

(51) Int. Cl. B01D 46/00; B01D 46/24; B01D 46/42; F24F 8/108; F24F 12/00; F24F 13/28

(52) U.S. Cl. CPC B01D 46/001; B01D 46/0004; B01D 46/2411; B01D 46/4227; F24F 8/108; F24F 12/006; F24F 13/28; B01D 2265/04; B01D 2279/50

(57) ABSTRACT

A filtration apparatus may include an attachment component configured for coupling to a fresh air intake duct and establishing an attachment location to place a filter in fluid communication with air flowing through the fresh air intake duct. The apparatus may also include the filter comprising a frame and filter material configured to remove contaminants from the air flowing through the fresh air intake duct.

### CROSS-REFERENCE TO RELATED APPLICATION

The present application claims priority to U.S. Provisional Application No. 63/589,560 filed on Oct. 11, 2023 and entitled, Fresh Air Filter, the content of which is hereby incorporated by reference herein in its entirety.

### TECHNOLOGICAL FIELD

The present application relates generally to the field of filtering. More particularly, the present application relates to filtering of air flowing in a duct system. Still more particularly, the present application relates to filtration of outside air.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

Air filtration is used in buildings to capture dust, allergens, and other airborne particles within the building. Air filtration in buildings improves the lifespan of heat, ventilation, and air conditioning systems and minimizes the need for repairs.

Air filtration may be used in a variety of different applications, including residential buildings. Air filtration systems in residential buildings are used to capture pollen, dust, pet dander, dirt, and allergens from the air within the residence. Conventional residential air filtration systems filter air flowing through the forced air system of the home including the heat, ventilation, and air conditioning system of the building or home. These conventional systems may be effective at filtering the air already inside a residential building, or otherwise enclosed environments. However, fresh air intakes that supply the air for conventional air flow systems of residential buildings often extend from the outside of the home to a mechanical room without any filtration at all.

### SUMMARY

In one or more examples, a filtration apparatus may include an attachment component configured for coupling to a fresh air intake duct. The attachment component may establish an attachment location to place a filter in fluid communication with air flowing through the fresh air intake duct. The apparatus may also include the filter. The filter may include a frame and filter material configured to remove contaminants from the air flowing through the fresh air intake duct.

In one or more examples, a system for filtering fresh air entering a building may be provided. The system may include a fresh air intake duct configured for extending from an exterior area of the building to an interior area of the building. The system may also include a filtration apparatus configured for arrangement on an interior end of the fresh air intake duct. The filtration apparatus may include an attachment component configured for coupling to the fresh air intake duct. The attachment component may establish an attachment location to place a filter in fluid communication with air flowing through the fresh air intake duct. The filtration apparatus may also include the filter. The filter may include a frame and filter material configured to remove contaminants from the air flowing through the fresh air intake duct.

In one or more examples a method of filtering air through a fresh air filtration system may be provided. The method may include passively receiving fresh air into a fresh air intake duct of a building and controlling flow of the fresh air into a mechanical room of the building. The method may also include filtering the fresh air using a filtration apparatus attached to an interior end of the fresh air intake duct.

### BRIEF DESCRIPTION OF THE FIGURES

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1A is a schematic diagram of a fresh air intake having a fresh air filter apparatus, according to one or more examples.

FIG. 1B is a schematic diagram of an example of a fresh air filter apparatus of the present disclosure including an example heat recovery system.

FIG. 2A is a perspective view the fresh air filter apparatus of FIG. 1A, according to one or more examples.

FIG. 2B is an exploded perspective thereof.

FIG. 3 is a perspective view of the fresh air filter apparatus of FIGS. 2A-2B including a friction securing feature, according to one or more examples.

FIG. 4 is a perspective view of another example of a fresh air filter apparatus, according to one or more examples.

FIG. 5A is a perspective view of still another example of a fresh air filter apparatus, according to one or more examples.

FIG. 5B is a perspective view of the fresh air filter apparatus of FIG. 5A with an access panel in an open position.

FIG. 6A is a perspective view of still another example of a fresh air filter apparatus, according to one or more examples.

FIG. 6B is a perspective view of the fresh air filter apparatus of FIG. 5A with an access panel in an open position.

FIG. 7 is a perspective view of a filter in isolation from the filter apparatuses of FIGS. 5A-6B, according to one or more examples.

### DETAILED DESCRIPTION

The present application relates to filtration of fresh air that passes from outside of a building into the building via a fresh air intake. In particular, a fresh air filter apparatus may be provided on an interior end of a fresh air intake duct to provide filtration of outside air as it enters a building such as a home, commercial building, or other facility. In one or more examples, the fresh air filter apparatus may include an attachment component for securing an air filter to the interior end of the air intake duct. The system may solve the problem of relatively air-tight homes that focus on filtering the air within the home in the heating, ventilating, and air conditioning system, but fail to address the contaminates that flow freely into the home via the fresh air intake system.

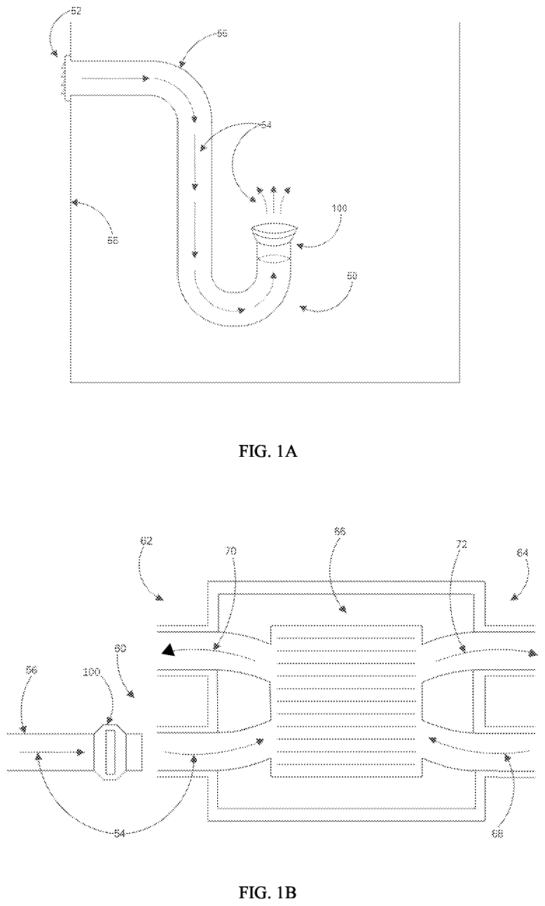

FIG. 1A illustrates a fresh air filtration system 50. The system 50 may be configured to provide a flow path for fresh air 54 from outside of the building to flow through the fresh air intake tube or duct 56 from an exterior grate 52 located on an external wall 58 to the fresh air filter apparatus 100 and into the building. As an example, the fresh air filtration system 50 shown may include a fresh air intake tube or duct 56 that extends from the external wall 58 through and/or along trusses, floor joists or other structures to a mechanical room of the building such as a room that includes a furnace and/or a hot water heater. The tube or duct 56 may then drop down into the mechanical room and may include a u-shaped bend near its interior most end. In other examples, the tube or duct may simply end or be terminated slightly above the floor and may face downward. Still other interior end configurations may be provided. The tube or duct may be a flexible duct such as corrugated tubing and may also be surrounded with insulation. The filter apparatus 100 may be provided on the interior most end of the tube or duct 56. In one or more examples, the system 50 may be particularly well suited for supplying fresh air to the furnace and/or hot water heater in the mechanical room to aid with combustion.

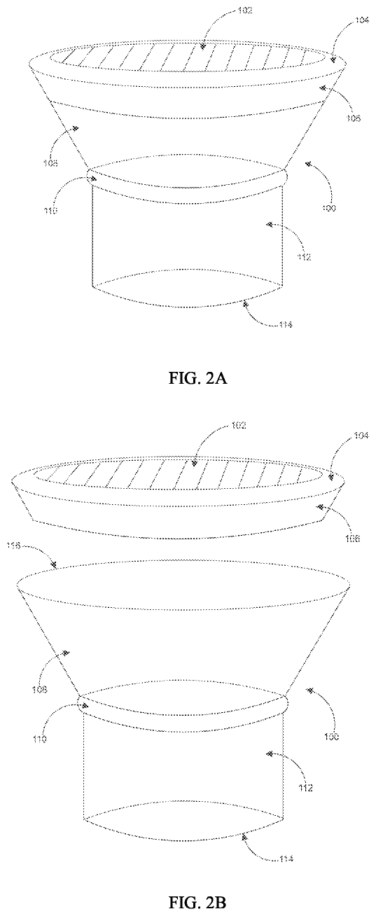

FIG. 2A shows a perspective view of one example of a fresh air filter apparatus 100. The filter apparatus may be configured for attachment to the interior end of the tube or duct 56 and further configured to filter air entering the building through the tube or duct 56. As shown, the filter apparatus 100 may include a filter 104 and an attachment component 114. FIG. 2B shows a perspective view of the fresh air filter apparatus 100 with the filter 104 detached from the attachment component 114.

The attachment component 114 may be configured to facilitate attachment of the filter 104 to the tube or duct 56. In one or more examples, the attachment component 112 may include a cylindrical component 112 particularly sized and adapted for insertion into the interior end of the tube or duct 56. The cylindrical component may be partially inserted into the tube or duct leaving another portion exposed such that the filter 104 may be attached thereto. This may be particularly useful due to the sometime flexible nature of the tube or duct 56. That is, the attachment component 112 or cylindrical component thereof may be a relatively rigid cylinder providing for a connection of the filter thereto. In one or more examples, a conical shaped top or interior most end 108 defining an opening 116 may be provided on the attachment component and extending from the cylindrical component. While shown with a relatively large taper, a smaller amount of taper may also be provided. The conical shaped top 108 may help resisted over insertion of the attachment component 114 into the fresh air intake tube or duct 56. In one or more examples, an additional insertion control mechanism may be provided in the form of a tubular shaped band 110. The band 110 may be arranged between the cylindrical component 112 and the conical shaped top 108 to further prevent or resist the fresh air filter apparatus 100 from falling into or being inserted too far into the fresh air intake tube or duct 56. That is, the band 110 may be a thickened rim of the cylindrical component 112 and may include an inner diameter that is the same as the cylindrical component, but an outer diameter larger than the tube or duct 56. The attachment component 114 including the cylindrical component 112 and the conical top portion 108 may be made of plastic, metal, a combination of the foregoing, or any material known for maintaining a specified shape. The tubular shaped band 110 may be made of plastic, rubber, metal, a combination of the foregoing, or any material known for holding a tubular shape.

With continued reference to FIGS. 2A and 2B, the filter 104 may be configured for arrangement on and engagement with the attachment component 114. In one or more examples, the filter may include a filter material 102 and a fastening component 106. The filter material 102 may be comprised of cloth, paper, a combination of the foregoing, or any other material known for filtering particles. The filtering material 102 may be configured in a generally cylindrical, generally square, or generally rectangular shape or any shape suitable for filtering air. The filtering material 102 may be pleated, corrugated, substantially flat, or another formation suitable for filtering air. In one or more examples, the pleated or corrugated formations may provide a higher surface area than a flat formation. The filter material may include a frame that may be constructed from cloth, paper, cardboard, or the like.

The filter 104 may be attached to the attachment component 114 using the fastening component 106. The fastening component may be configured for engaging the attachment component and/or, in particular, the conical shaped top 108 to hold the filter material 102 against the end of thereof in a position extending across the opening 116. In one or more examples, the fastening component 106 may include an elastic band, a clasp, a set of straps, a combination of the foregoing, or any other device or method of attachment. The attachment component may be in the form of a continuous apron or shroud, for example, that can be slipped or stretched over the conical shaped top 108 of the attachment component 114. The fastening component 106 may be secured (e.g., glued, stitched, pinned, etc.) to the frame of the filter material 102 and may be used to hold the filter on the attachment component.

As shown in FIG. 2B, the filter 104 may be detached from the attachment component 114 for reuse or replacement. In other examples, the filter 104 may be fixedly or more permanently attached to the attachment component 114. As a means of example, the embodiment of the fresh air filter apparatus 100 shown includes the filter 104 having a fastening component 106 comprised of an elastic material for temporary attachment to the attachment component 114.

When a user desires to use the example fresh air filter apparatus 100 shown in FIGS. 2A and 2B, the user may attach the filter 104 to the attachment component 114 by securing the fastening component 106 to the attachment component 114. For example, in the case of an elastic band or shroud, the fastening component may be stretched over the conical top portion 108 and released so as to cinch around the conical top portion. It is noted that the elasticity of the band or shroud may be relatively high or low and since the airflow within the fresh air intake is passive flow, in contrast to forced air, the fit of the fastening component 106 on the conical top 108 may be relatively loose. The user may detach the filter 104 from the attachment component 114 by removing the fastening component 106 from the attachment component 114 and moving the filter 104 away from the attachment component 114. That is, in the case of an elastic band or shroud, the filter pulled off of the attachment component where the fastening component 106 may be stretched either directly or by pulling on the filter material such that it releases or slips around and off the conical top 108 of the attachment component 114. The fresh air filter apparatus 100 may be attached to a fresh air intake tube or duct 56 by placing the cylindrical component 112 into the fresh air intake tube 56. Additional fastening may be done to secure the fresh air filter apparatus 100 to the fresh air intake tube or duct 56. For example, a zip tie, cylindrical clamp, screws, or other mechanism for securing the attachment component 114 to the tube or duct 56 may be provided. While not likely a regular event, the user may remove the fresh air filter apparatus 100 from the fresh air intake tube or duct 56 by moving the fresh air filter apparatus 100 away from the fresh air intake tube or duct 56 until the cylindrical shaped based 112 is completely removed from the fresh air intake tube or duct 56. Where the attachment component is fastened to the intake tube or duct 56, such fasteners may be removed before removal of the attachment component.

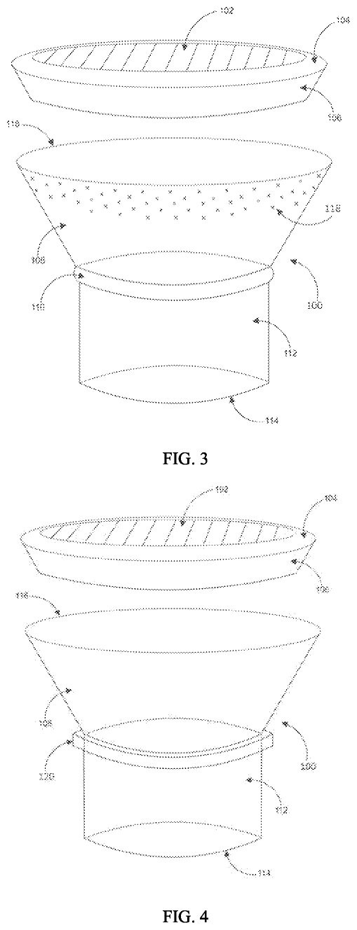

FIG. 3 illustrates a perspective view of the fresh air filter apparatus 100 of FIGS. 2A-2B. The fresh air filter apparatus 100 may be the same or similar to the filter apparatus 100 shown in FIGS. 2A-B and may also include a friction feature 118. The friction feature 118 is shown on the outer surface of the conical shaped top 108. The friction feature may be provided to engage with the fastening component 106 of the filter 104 to resist slippage and/or inadvertent removal of the filter 104 from the attachment component. The friction feature 118 may include grit, sand, cuts in the material or surface of the material, glue, adhesive, or a combination of the foregoing including any abrasive material that causes friction or adhesive material.

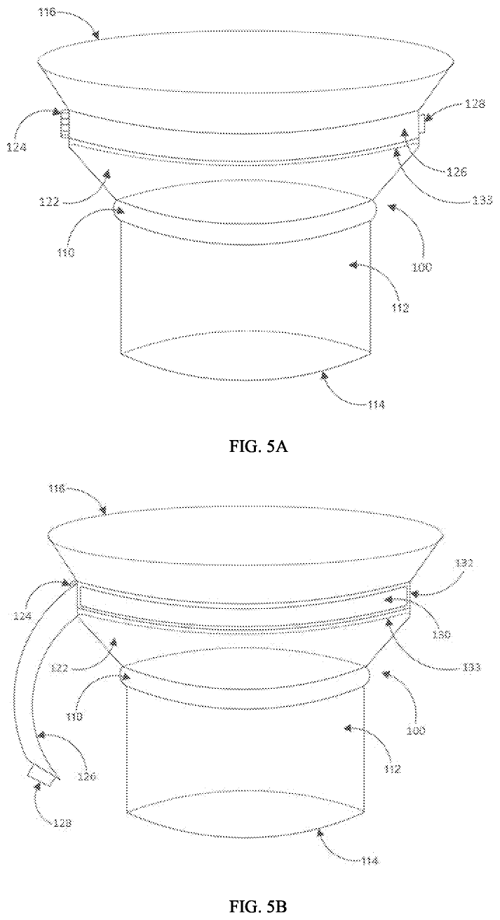

FIG. 4 is a perspective view of an example fresh air filter apparatus 100 of the present disclosure. In the embodiment depicted in FIG. 4, the fresh air filter apparatus 100 may be the same or similar to the fresh air filter apparatus shown in FIGS. 2A-3. However, rather than a band 110, the present apparatus 100 may include an L-shaped band 120. That is, the band 120 may, when viewed in cross-section, have an L-shape. The band may be oriented in an inverted orientation with one horizontal leg of the L-shape extending away from the cylindrical component 112 to the heel of the L-shape and one vertical leg of the L-shape extending downward from the heel of the L-shape. In this manner, when the attachment component 114 is placed on the tube or duct 56, the L-shaped band may hook over the tube or duct 56 where the horizontal leg of the L-shaped band abuts the circumferential end of the tube or duct 56 and the vertical leg slips down along the outside of the tube or duct 56 thereby helping to resisting lateral dislodgment of the attachment component 114.

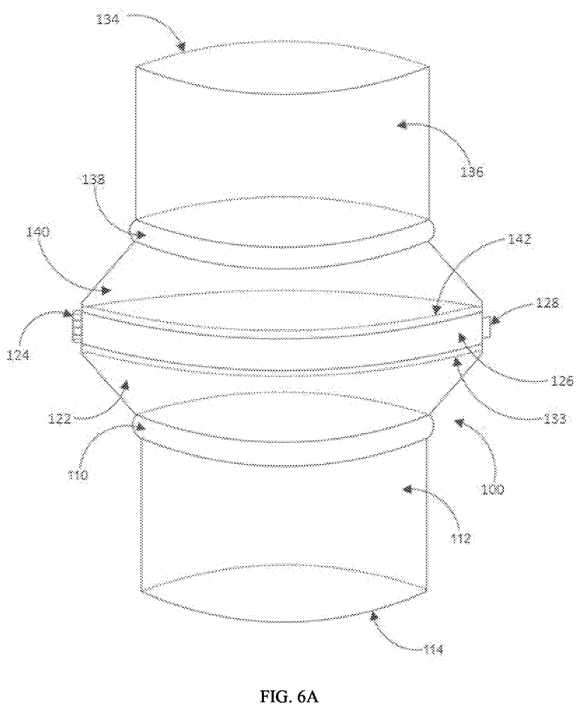

FIGS. 5A and 5B are perspective views of the fresh air filter apparatus 100 of FIGS. 2A-3 (e.g., including the band 110 not the L-shaped band 120) and further including a cartridge housing. That is, as shown, a cartridge housing 122 may be arranged within the height of the conical shaped top 108 and may be configured to receive and hold a filter 104. The cartridge housing may be generally cylindrically shaped having sidewall that may be sized and shaped slightly smaller than the opening 116 as defined by its position along the conical shaped top 108. In one or more examples, the cartridge housing 122 may include an opening or slot 132 in the sidewall for receiving a filter 130. That is, the opening or slot may be sized slightly larger than the filter 130 and may include a similar side profile such that the filter may be inserted through the slot 132 (e.g., similar to a coin slot). Filter 130 may be the same or similar to the filter 104, but may not include the fastening component 106. The cartridge housing 122 may also include a curved rectangular cover or door 126 adapted for providing selective access to the opening or slot in the cartridge housing 122. The cover or door 126 may open and close and may cover the opening or slot in the sidewall of the cartridge housing 122 when the cover or door 126 is closed. In one or more examples, the cover or door may be pivotally attached to the cartridge housing with a pivotal attachment 124, such as a hinge, to cover the slot 132. While a hinge is shown, the pivotal attachment may also be provided by pivot pins, bolts, bearings, bushings, rods, brackets, a flexible material (e.g., living hinge) a combination of the foregoing, or any other device or method of attachment known for pivotal connections. The rectangular cover 126 may include a tab 128 for grasping the cover for opening and closing the cover 126. In some examples, while not shown, a latch or other mechanism for holding the door 126 in the closed condition may be provided. FIG. 5A shows the cover in a closed condition and FIG. 5B shows the cover in an opening position. As shown, an internal ridge 133 may also be provided at or near the bottom of the cartridge housing for purposes of supporting the air filter 130. In one or more examples, the ridge 133 may be provided as part of the cartridge housing and in other examples, the ridge 133 may be provided as part of the conical shaped top 108. In either case, the ridge 133 may include a generally annular shape that provides a radially inward extending ridge 133 with an inner diameter slightly smaller than the peripheral diameter or other crossing dimension of the filter 130 so as to support the filter from an underside thereof. While not shown, in some examples, an upper ridge may be provided as well so as to hold the filter in the system and avoid dislodgement from, for example, exterior pressure changes caused by wind or other factors. It is to be appreciate that while the cartridge housing 122 is shown to be positioned along the length of the conical shaped top (e.g., within a height thereof), the cartridge housing may also be arranged at an end of the conical shaped top 108 (e.g., at opening 116).

Use of the apparatus of FIGS. 5A and 5B may the same or similar to that of FIGS. 2A-3, except that placement and/or replacement of the filter may include opening the door 126 and inserting a filter 130 allowing it to rest on ridge 133 and/or removing a filter 130 and replacing it with a new filter 130. The door 126 may then be closed or closed and latched. This may be in lieu of using the fastening component 106 to stretch over the conical shaped top.

Given the fact that fresh air intake systems bring in untreated air from outside of the building, in cold climates or during cold season, the fresh air intake can contribute to heat losses in a building, particularly in or around the mechanical room. FIG. 1B illustrates a heat recovery system 60 comprising an example fresh air filter apparatus 100 in accordance with the examples described herein. The fresh air filter apparatus 100 may be configured for attaching to a fresh air intake tube 56 as describe herein, but also may be configured for attaching to a heat recovery core 66. The heat recovery core 66 may be configured to allow heat to transfer to incoming fresh flowing air 54 before incoming fresh flowing air 54 mixes with air in an interior of the building 64. That is, the heat recovery core 66 may be configured to interior stale and heated air 68 into a heat exchanger with relatively cold fresh air 54. The heat from the interior heated air 68 may transfer to the incoming fresh air 54 before the fresh air enters the building as warmer fresh air 72. The now cooler stale air 70 may be exhausted to the outside of the building.

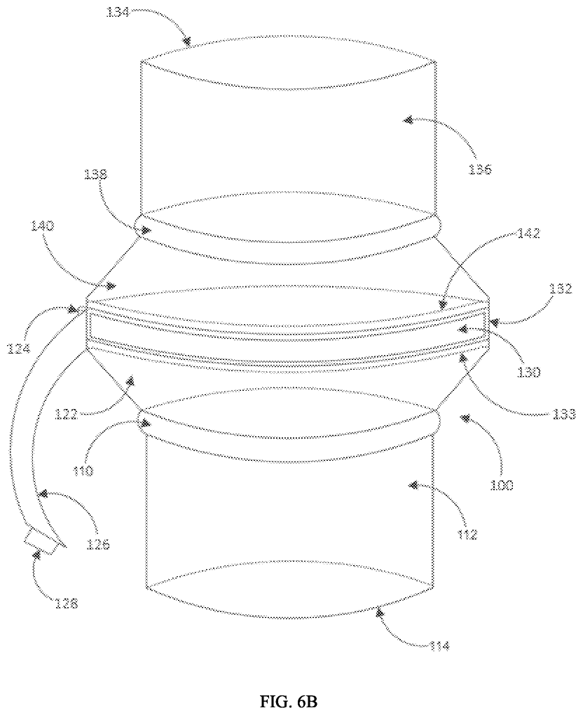

FIGS. 6A and 6B are perspective views of an example fresh air filter apparatus 100 of the present disclosure. In the embodiment depicted in FIGS. 6A and 6B, an example fresh air filter apparatus 100 comprises an attachment component 114. An attachment component 114 has a cylindrical component 112 fixedly attached to a conical shaped top 108 with a cylindrical portion 122 attached to a mirrored conical shaped piece 140 attached to a cylindrical shaped top 136 on the proximal end defining an opening 134. Tubular shaped bands 110 and 138 may be provided between the cylindrical components 112/136 and the conical tops 108/136 to resist or prevent over insertion. It is to be appreciated that while conical portions have been show in several of the embodiments, the bands 110/136 may be sufficient to avoid over insertion and the conical portions may be cylindrical and sized the same as the cylindrical components 112/136. That is, the conical shape may be replaced with a cylindrical shape in all examples. However, there may be benefit to the conical shape since it may increase the surface area of the air filter and, as such, may help to avoid overly restricting the air flow. As with the example in FIGS. 5A and 5B, ridges 133 and 142 may be provided to assist with maintaining the position of the filter 130.

The apparatus 100 shown in FIGS. 6A and 6B may be used in the same manner as the examples of FIGS. 5A-5B. However, and in addition, the cylindrical component 136 may be used to connect to an additional tube or duct to feed the filtered fresh air to a heat recovery core as shown in FIG. 1B.

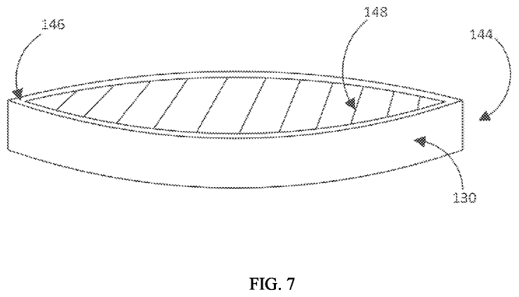

FIG. 7 shows a perspective view of the air filter 130 suitable for use with the examples shown in FIGS. 5A-6B. That is, the filter 130 may be suitable for insertion and removal from horizontal slot 132 of the example fresh air filter apparatus 100 shown in FIGS. 5A, 5B, 6A, and 6B. The air filter 130 may be the same as the filter 102, except that it may not include a fastening component 106. That is, the filter 130 may include a filtering material 148 attached to a frame 146. The filtering material 148 may be the same or similar to the filter material 102 and the frame 146 may be the same as the frame of the filter 104. In one or more examples, the filter 130 may include a tab or flap extending laterally away from the frame to form a handle or graspable element. The tab or flap may be flexible so as to allow it to collapse when door 126 is closed, but to be used to pull the filter from the cartridge housing 122.

The following, non-limiting examples detail certain aspects of the present subject matter to solve the challenges and provide the benefits discussed herein, among others.

Example 1 is a filtration apparatus comprising an attachment component configured for coupling to a fresh air intake duct and establishing an attachment location to place a filter in fluid communication with air flowing through the fresh air intake duct; and the filter comprising a frame and filter material configured to remove contaminants from the air flowing through the fresh air intake duct.

In example 2, the subject matter of example 1 optionally includes wherein the filter comprises a fastening component configured for securing the filter to the attachment component.

In example 3, the subject matter of example 2 optionally includes wherein the fastening component comprises an elastic shroud configured to be slipped over a top of the attachment component.

In example 4, the subject matter of example 3 optionally includes wherein the attachment component comprises a cylindrical component and a conical shaped top, the conical shaped top configured for being surrounded by the elastic shroud to retain the filter on the attachment component.

In example 5, the subject matter of any one or more of examples 1 to 4 optionally includes wherein the attachment component comprises a cylindrical component and a top separated by a thickened rim configured to resist over insertion of the attachment component into the fresh air intake duct.

In example 6, the subject matter of any one or more of examples 1 to 4 optionally includes wherein the attachment component comprises a cylindrical component and a top separated by an L-shaped band configured to resist over insertion of the attachment component into the fresh air intake duct.

In example 7, the subject matter of any one or more of examples 2 to 6 optionally includes wherein the attachment component comprises a friction feature configured for engagement with the fastening component of the filter.

In example 8, the subject matter of example 7 optionally includes wherein the friction feature comprises cuts on the attachment component.

In example 9, the subject matter of any one of examples 7 to 8 optionally includes wherein the friction feature comprises an adhesive on the surface of the attachment component.

In example 10, the subject matter of example 1 optionally includes wherein the attachment component comprises a cartridge housing configured to receive the filter.

In example 11, the subject matter of example 10 optionally includes wherein the cartridge housing comprises a sidewall having a slot for receiving the filter.

In example 12, the subject matter of example 11 optionally includes wherein the cartridge housing comprises a door adapted for providing selective access to the slot.

In example 13, the subject matter of example 12 optionally includes wherein the door is pivotally secured to the cartridge housing for opening and closing the door.

In example 14, the subject matter of any one or more of examples 10 to 13 optionally includes wherein the air filter includes a tab.

In example 15, the subject matter any one or more of examples 10 to 14 optionally includes wherein the attachment component comprises a first cylindrical component on a first side of the cartridge housing and a second cylindrical component on a second side of the cartridge housing.

Example 16 is a system for filtering fresh air entering a building, the system comprising: a fresh air intake duct configured for extending from an exterior area of the building to an interior area of the building; a filtration apparatus configured for arrangement on an interior end of the fresh air intake duct, the filtration apparatus including: an attachment component configured for coupling to the fresh air intake duct and establishing an attachment location to place a filter in fluid communication with air flowing through the fresh air intake duct; and the filter comprising a frame and filter material configured to remove contaminants from the air flowing through the fresh air intake duct.

In example 17 the subject matter of example 16 optionally includes a heat recovery system configured to heat flowing fresh air from the fresh air intake duct using interior air from the building.

In example 18, the subject matter of example 17 optionally includes wherein the heat recovery system comprises a heat recovery core coupled to fresh air intake duct downstream of the filtration apparatus.

Example 19 is a method of filtering air through a fresh air filtration system, the method comprising: passively receiving fresh air into a fresh air intake duct of a building; controlling flow of the fresh air into a mechanical room of the building; and filtering the fresh air using a filtration apparatus attached to an interior end of the fresh air intake duct.

In Example 20 the subject matter of example 19 optionally includes heating the fresh air using a heat recovery system.

Example 21 is an apparatus comprising means to implement any of Examples 1-20.

Example 22 is a system to implement any of Examples 1-20.

Example 23 is a method to implement any of Examples 1-20.

Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention. It will be understood that certain features and sub-combinations are of utility and may be employed without reference to other features and sub-combinations and are contemplated within the scope of the claims. Not all steps listed in the various figures need be carried out in the specific order described.

What is claimed is:

1. A filtration apparatus comprising:
an attachment component configured for coupling to a fresh air intake duct and establishing an attachment location to place a filter in fluid communication with air flowing through the fresh air intake duct; and
the filter comprising a frame and filter material configured to remove contaminants from the air flowing through the fresh air intake duct.

2. The filtration apparatus of claim 1, wherein the filter comprises a fastening component configured for securing the filter to the attachment component.

3. The filtration apparatus of claim 2, wherein the fastening component comprises an elastic shroud configured to be slipped over a top of the attachment component.

4. The filtration apparatus of claim 3, wherein the attachment component comprises a cylindrical component and a conical shaped top, the conical shaped top configured for being surrounded by the elastic shroud to retain the filter on the attachment component.

5. The filtration apparatus of claim 3, wherein the attachment component comprises a cylindrical component and a top separated by a thickened rim configured to resist over insertion of the attachment component into the fresh air intake duct.

6. The filtration apparatus of claim 3, wherein the attachment component comprises a cylindrical component and a top separated by an L-shaped band configured to resist over insertion of the attachment component into the fresh air intake duct.

7. The filtration apparatus of claim 2, wherein the attachment component comprises a friction feature configured for engagement with the fastening component of the filter.

8. The filtration apparatus of claim 7, wherein the friction feature comprises cuts on the attachment component.

9. The filtration apparatus of claim 7, wherein the friction feature comprises an adhesive on the surface of the attachment component.

10. The filtration apparatus of claim 1, wherein the attachment component comprises a cartridge housing configured to receive the filter.

11. The filtration apparatus of claim 10, wherein the cartridge housing comprises a sidewall having a slot for receiving the filter.

12. The filtration apparatus of claim 11, wherein the cartridge housing comprises a door adapted for providing selective access to the slot.

13. The filtration apparatus of claim 12, wherein the door is pivotally secured to the cartridge housing for opening and closing the door.

14. The filtration apparatus of claim 10, wherein the air filter includes a tab.

15. The filtration apparatus of claim 10, wherein the attachment component comprises a first cylindrical component on a first side of the cartridge housing and a second cylindrical component on a second side of the cartridge housing.

16. A system for filtering fresh air entering a building, the system comprising:
a fresh air intake duct configured for extending from an exterior area of the building to an interior area of the building;
a filtration apparatus configured for arrangement on an interior end of the fresh air intake duct, the filtration apparatus including:
an attachment component configured for coupling to the fresh air intake duct and establishing an attachment location to place a filter in fluid communication with air flowing through the fresh air intake duct; and
the filter comprising a frame and filter material configured to remove contaminants from the air flowing through the fresh air intake duct.

17. The system of claim 16, further comprising a heat recovery system configured to heat flowing fresh air from the fresh air intake duct using interior air from the building.

18. The system of claim 17, wherein the heat recovery system comprises a heat recovery core coupled to fresh air intake duct downstream of the filtration apparatus.

19. A method of filtering air through a fresh air filtration system, the method comprising:
passively receiving fresh air into a fresh air intake duct of a building;
controlling flow of the fresh air into a mechanical room of the building; and
filtering the fresh air using a filtration apparatus attached to an interior end of the fresh air intake duct.

20. The method of claim 19, further comprising heating the fresh air using a heat recovery system.
